(19) United States
(12) Patent Application Publication
(10) Pub. No.: US 2023/0388696 A1
(43) Pub. Date: Nov. 30, 2023

(54) HEAD-MOUNTED SPORTS EQUIPMENT WITH FREELY ADJUSTABLE LENGTH

(71) Applicant: Shenzhen Molang Electronics Co., Ltd., Shenzhen (CN)

(72) Inventor: WENSHENG CHEN, Ji'an (CN)

(21) Appl. No.: 17/844,658

(22) Filed: Jun. 20, 2022

(30) Foreign Application Priority Data
May 25, 2022 (CN) 202210576727.9

(51) Int. Cl. H04R 1/10; H04R 1/34

(52) U.S. Cl. CPC H04R 1/105; H04R 1/1075; H04R 1/345; H04R 1/1041; H04R 1/1008; H04R 2420/07

(57) ABSTRACT

A head-mounted sports equipment with freely adjustable length, comprising a ring-shaped main structure, which is configured to be worn on the head of a user, the main structure comprises a front ring structure and a rear ring structure, which are both strip-shaped semi-rings. The ends of the front ring structure and the rear ring structure are provided with quick release structure, and the front ring structure and the rear ring structure form an annular main structure by sequential connection of the ends of the quick release structure. The main structure is provided with a Bluetooth headset playback component at a position corresponding to the user's ear. The rear ring structure is provided with a rotary button adjustment mechanism at the back of the user's head for adjusting the tightness of the rear ring structure.

### CROSS-REFERENCE TO RELATED APPLICATIONS

This is a U.S. patent application which claims the priority and benefit of Chinese Patent Application Number 202210576727.9, filed on May 25, 2022, the disclosure of which is incorporated herein by reference in its entirety.

### TECHNICAL FIELD

The present application relates to the technical field of sports equipment, in particular, to a head-mounted sports equipment with freely adjustable length.

### BACKGROUND

Sports headsets are headsets worn when exercising. They are headsets that are different from ordinary headsets and can be stably fixed on the wearing part. This kind of headset will not cause the headset to fall from the ear due to body movement, but also generally has the characteristics of anti-splash, light weight, etc., and has good ventilation performance, and belongs to the open headset. However, there are also inconvenient situations when using this kind of headset. First of all, the headsets are heavy, the pressure is concentrated on the ears, and the burden on the ear is too large; some headsets use wired transmission, which is easy to fall off during movement, and wired headsets will beat the body during movement, which will increase discomfort.

There are also head-mounted headsets on the market now, but the size of most headsets cannot be adjusted according to the size of the head of different users. When the head is small, it is easy to shake the device, which increases the discomfort.

### SUMMARY

The purpose of the present application is to provide a head-mounted sports equipment with a freely adjustable length, which can adjust the tightness of the main structure, so as to adjust the tightness according to the head size of different users, and improve the wearing comfort of the device.

Embodiments of the present application are implemented as follows:

The embodiment of the present application provides a head-mounted sports equipment with freely adjustable length, comprising a ring-shaped main structure, which is configured to be worn on the head of a user, the main structure comprises a front ring structure and a rear ring structure, which are both strip-shaped semi-rings, the ends of the front ring structure and the rear ring structure are provided with quick release structure, and the front ring structure and the rear ring structure form an annular main structure by sequential connection of the ends of the quick release structure;
the main structure is provided with a Bluetooth headset playback component at a position corresponding to the user's ear;
the rear ring structure is provided with a rotary button adjustment mechanism at the back of the user's head, which is configured to adjust the tightness of the rear ring structure.

In some embodiments of the present application, the quick release structure is a pop-up inserting structure.

In some embodiments of the present application, the rear ring structure comprises two strip-shaped annular belts, and one end of any one of the strip-shaped annular belts is connected to the end of the quick-release structure, and the other end of any one of the strip-shaped annular belts is connected to the rotary button adjustment mechanism.

In some embodiments of the present application, the rotary button adjustment mechanism comprises a casing with a second cavity, a gear is arranged in the second cavity, a rotary button is arranged on the rear side of the casing, and the rotary button is coaxially arranged with the gear;
both of the two strip-shaped annular belts are slidably connected to the casing, and the ends of the two strip-shaped annular belts extending into the second cavity are provided with a rack respectively, and the two racks are respectively arranged on the upper and lower sides of the gear, and both mesh with the gear.

In some embodiments of the present application, further comprising a power supply device for supplying power to the Bluetooth headset playback component, the power supply device being provided on the main body structure.

In some embodiments of the present application, the power supply device comprises a battery and a battery control board, and the battery and the battery control board are both arranged in the second cavity;
further comprising an operating component arranged in the second cavity and an operation circuit board electrically connected with the operating component, wherein the battery control board, the operation circuit board and the Bluetooth headset playback component are all electrically connected to the battery.

In some embodiments of the present application, the rear ring structure is provided with a first cavity at a position corresponding to the user's ear, a speaker is arranged in the first cavity, and the speaker is electrically connected to the battery.

In some embodiments of the present application, the rear ring structure is also provided with a sound guide structure for guiding the sound emitted by the speaker at the position corresponding to the user's ear, and an end of the sound guide structure close to the user's ear is provided with a sound outlet.

In some embodiments of the present application, the main structure is also provided with a positioning module and a step counting function module, both of which are electrically connected to the power supply device.

In some embodiments of the present application, the outside of the front ring structure and the rear ring structure are wrapped with sweat absorbing structure.

Compared with the prior art, the embodiments of the present application have at least the following advantages or beneficial effects:

The present application provides a head-mounted sports equipment with freely adjustable length, comprising a ring-shaped main structure, which is configured to be worn on the head of a user, the main structure comprises a front ring structure and a rear ring structure, which are both strip-shaped semi-rings. The ends of the front ring structure and the rear ring structure are provided with quick release structure, and the front ring structure and the rear ring structure form an annular main structure by sequential connection of the ends of the quick release structure. The main structure is provided with a Bluetooth headset playback component at a position corresponding to the user's ear. The rear ring structure is provided with a rotary button adjustment mechanism for adjusting the tightness of the rear ring structure at the back of the user's head.

The sports equipment adopts a ring-shaped main structure, which can be worn on the user's head, so that the user's movement will not be affected. Specifically, the main structure comprises a front ring structure and a rear ring structure. When worn, the front ring structure is located on the user's forehead and the rear ring structure is located on the back of the user's head. The front ring structure and the rear ring structure are both strip-shaped semi-rings, which are small in size and light in weight, which improves the wearing comfort of users. In addition, the ends of the front ring structure and the rear ring structure provide with quick release structure, and the front ring structure and the rear ring structure can be connected together in sequence by the quick release structure to form an annular main structure. And it is also easy to disassemble, so as to replace or clean the front ring structure or the rear ring structure, and improve the convenience of use. In addition, the main structure is provided with a Bluetooth headset playback component at a position corresponding to the user's ear, which can be used to play music, so that this kind of sports equipment is not only with the function of headset, but also is without burden after wearing.

Further, the rear ring structure is also provide with a rotary button adjustment mechanism at the back of the user's head for adjusting the tightness of the rear ring structure, so that the tightness can be adjusted according to the size of the head of different users. This improves the wearing comfort of the equipment, and adopts a rotary button adjustment mechanism, that is, the adjustment can be realized by turning the button, and the operation is simple and convenient.

### BRIEF DESCRIPTION OF DRAWINGS

In order to illustrate the technical solutions of the embodiments of the present application more clearly, the following briefly introduces the accompanying figures used in the embodiments. It should be understood that the following figures only show some embodiments of the present application, and therefore do not should be seen as a limitation of scope. For those of ordinary skill in the art, other related drawings can also be obtained from these figures without any creative effort.

FIG. 1 is a schematic structural diagram of a head-mounted sports equipment of the present application;

FIG. 2 is a schematic cross-sectional view of the head-mounted sports equipment of the present application;

FIG. 3 is a schematic cross-sectional view of a quick release structure;

FIG. 4 is a partial enlarged view at A in FIG. 2;

FIG. 5 is a partial enlarged view at B in FIG. 2;

FIG. 6 is the schematic diagram of the rotary button adjustment mechanism;

FIG. 7 is the sectional schematic diagram of FIG. 6;

FIG. 8 is (side view) a wearing effect diagram of the head-mounted sports equipment of the present application;

FIG. 9 is a (front view) wearing effect diagram of the head-mounted sports equipment of the present application;

FIG. 10 is a (rear view) wearing effect diagram of the head-mounted sports equipment of the present application.

1-Front ring structure, 2-Rear ring structure, 201-Strip-shaped annular belt, 21-First cavity, 211-Speaker, 22-Second cavity, 221-Operation circuit board, 222-Battery, 223-Battery board, 224-Operating component, 23-Sound guide structure, 231-Sound Outlet, 24-Rotary button adjustment mechanism, 241-Rotary button, 242-Gear, 243-Rack, 244-Casing, 25-Quick release Structure, 251-First connection Buckle, 2511-Protrusion, 252-Spring cover, 253-Torsion spring, 254-Pin, 255-Second connection buckle, 3-Positioning module, 4-Step counting function module, 5-Bluetooth headset playback component, 6-Head, 7-Ear.

### DETAILED DESCRIPTION

In order to make the purposes, technical solutions and advantages of the embodiments of the present application clearer, the technical solutions in the embodiments of the present application will be clearly and completely described below with reference to the accompanying drawings in the embodiments of the present application. Obviously, the described embodiments are some, but not all, embodiments of the present application. The components of the embodiments of the application generally described and illustrated in the figures herein may be arranged and designed in a variety of different configurations.

Thus, the following detailed description of the embodiments of the application provided in the accompanying drawings are not intended to limit the scope of the application as claimed, but are merely representative of selected embodiments of the application. Based on the embodiments of the present application, all other embodiments obtained by those of ordinary skill in the art without creative efforts shall fall within the protection scope of the present application.

It should be noted that like numerals and letters refer to like items in the following figures, so once an item is defined in one figure, it does not require further definition and explanation in subsequent figures.

In the description of the present application, it should be noted that the terms “center”, “upper”, “lower”, “left”, “right”, “vertical”, “horizontal”, “inner”, “outer”, etc. which are used to indicate position or positional relationship are based on the position or positional relationship shown in the figures, and are only for the convenience of describing the application and simplifying the description, rather than indicating or implying that the indicated position or element must have a specific orientation and be constructed in a specific orientation and operation, therefore cannot be understood as a limitation of the present application. Furthermore, the terms “first”, “second”, “third”, etc. are only used to differentiate the description and should not be construed as indicating or implying relative importance.

Furthermore, the presence of the terms “horizontal”, “vertical”, “overhanging” etc. does not imply that the component is required to be absolutely horizontal or overhang, but rather may be slightly inclined. For example, “horizontal” simply means that its direction is more horizontal than “vertical”, it does not mean that the structure must be completely horizontal, but can be slightly inclined.

In the description of the present application, it should be noted that unless otherwise clearly specified and limited, the terms “installation”, and “connection” should be understood in a broad sense, for example, it can be a fixed connection or a detachable connection, or integrally connected; it can be a mechanical connection or an electrical connection; it can be directly connected, or indirectly connected through an intermediate medium, and it can be the internal communication between two components. For those skilled in the art, the specific meaning of the above-mentioned terms in the present application can be understood according to the specific circumstances.

In the description of the embodiments of the present invention, “a plurality of” means at least two.

In the description of the embodiments of the present application, it should also be noted that, unless otherwise expressly specified and limited, if the terms “set”, “install”, “connecting” and “connected” appear, they should be understood in a broad sense. For example, it may be a fixed connection, a detachable connection, or an integral connection; it may be a mechanical connection or an electrical connection; it may be a direct connection, or an indirect connection through an intermediate medium, or an internal connection between two components. For those of ordinary skill in the art, the specific meanings of the above terms in the present application can be understood according to specific situations.

### Embodiment

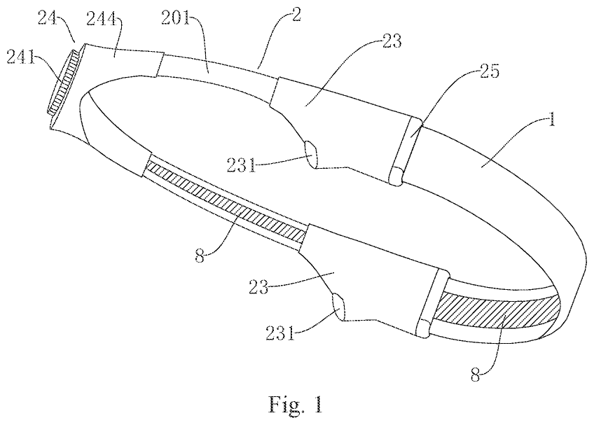

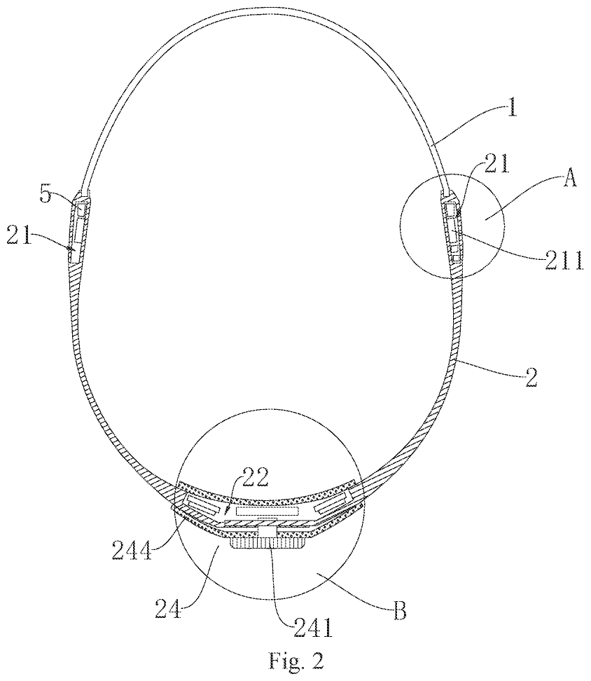

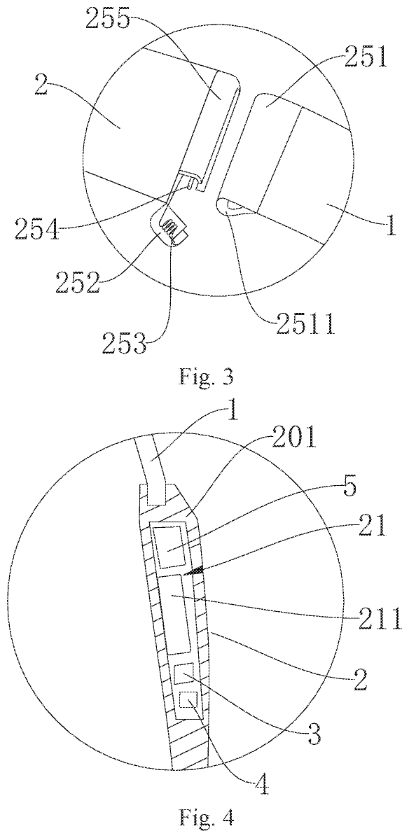

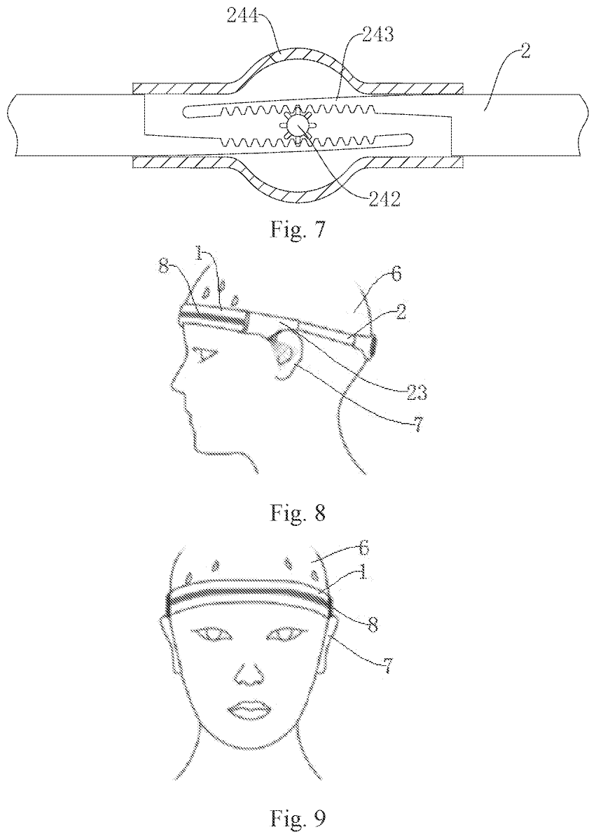

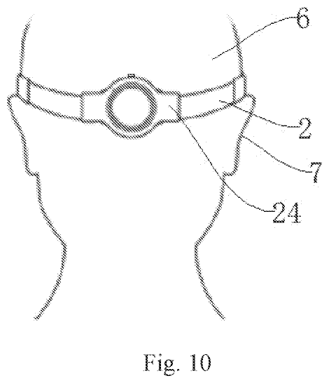

Please refer to FIG. 1 to FIG. 8, this embodiment provides a head-mounted sports equipment with freely adjustable length, comprising a ring-shaped main structure, which is configured to be worn on the user's head 6, the main structure comprises a front ring structure 1 and a rear ring structure 2, which are both strip-shaped semi-rings, the ends of the front ring structure 1 and the rear ring structure 2 are provided with quick release structure 25, and the front ring structure 1 and the rear ring structure 2 form an annular main structure by sequential connection of the ends of the quick release structure 25; the main structure is provided with a Bluetooth headset playback component 5 at a position corresponding to the user's ear 7; the rear ring structure 2 is provided with a rotary button adjustment mechanism 24 at the back of the user's head, which is configured to adjust the tightness of the rear ring structure 2.

In the present embodiment, the sports equipment adopts a ring-shaped main structure, which can be worn on the user's head 6, so that the user's movement will not be affected. Specifically, the main structure comprises a front ring structure 1 and a rear ring structure 2. When worn, the front ring structure 1 is located on the user's forehead and the rear ring structure 2 is located on the back of the user's head. The front ring structure 1 and the rear ring structure 2 are both strip-shaped semi-rings, which are small in size and light in weight, which improves the wearing comfort of users. In addition, the ends of the front ring structure 1 and the rear ring structure 2 provide with quick release structure 25, and the front ring structure 1 and the rear ring structure 2 can be connected together in sequence by the quick release structure 25 to form an annular main structure. And it is also easy to disassemble, so as to replace or clean the front ring structure 1 or the rear ring structure 2, and improve the convenience of use. In addition, the main structure is provided with a Bluetooth headset playback component 5 at a position corresponding to the user's ear, which can be used to play music, so that this kind of sports equipment is not only with the function of headset, but also without burden after wearing.

Further, the rear ring structure 2 is also provide with a rotary button adjustment mechanism 24 at the back of the user's head for adjusting the tightness of the rear ring structure 2, so that the tightness can be adjusted according to the size of the head of different users. This improves the wearing comfort of the equipment, and adopts a rotary button adjustment mechanism 24, that is, the adjustment can be realized by turning the button, and the operation is simple and convenient.

As a preferred embodiment, the above-mentioned Bluetooth headset playback component 5 can also be in the form of a bone conduction headset to improve playback sound quality.

In some implementations of this embodiment, the above-mentioned quick release structure is a pop-up inserting structure.

In the above-mentioned embodiment, the quick release structure 25 is a pop-up inserting structure. When in use, the front ring structure 1 and the rear ring structure 2 can be connected by quick inserting connection, the connection is simple and convenient, and the use effect is good.

Specifically, the pop-up inserting structure comprises a first connection structure 251 and a second connection structure 255 provided at the end of the rear ring structure 2. A spring cover 252 is rotatably connected to one end of the second connection buckle 255, a torsion spring 253 is arranged in the spring cover 252. One end of the torsion spring 253 extends out and abuts on the inner side of the second connection buckle 255. A pin 254 is arranged in the second connection buckle 255. The first connecting buckle 251 is arranged at one end of the front ring structure 1 close to the rear ring structure 2, and a protrusion 2511 is provided at one end of the first connecting buckle 251 close to the spring cover 252.

When connecting, after passing the end of the first connecting buckle 251 through the pin 254, the spring cover 252 on one side of the second connecting buckle 255 is buckled on the protrusion 2511 of the first connecting buckle 251, so as to realize the connection between the front ring structure 1 and the rear ring structure 2. This connection structure has good connection effect, the disassembly is simple and convenient, and the use is convenient.

Please refer to FIGS. 1, 2, 6 and 7, in some embodiments of the present application, the rear ring structure 2 comprises two strip-shaped annular belts 201, and one end of any one of the strip-shaped annular belts 201 is connected to the end of the quick release structure, the other end of any one of the strip-shaped annular belts 201 is connected with the adjustment mechanism of the rotary button 241.

In the above-mentioned embodiment, the rear ring structure 2 has two strip-shaped annular belts 201, and the two strip-shaped annular belts 201 are connected together by the adjustment mechanism of the rotary button 241 to form a semi-annular rear ring structure 2. Then, the two strip-shaped annular belts 201 are adjusted by the rotary button adjustment mechanism 24, so as to adjust the overall tightness of the main structure, so as to meet the wearing of users with different head sizes, and it has wide applicability.

In some implementations of this embodiment, the rotary button adjustment mechanism 24 comprises a casing 244 with a second cavity 22, a gear 242 is arranged in the second cavity 22, and a rotary button 241 is arranged on the rear side of the casing 244, and the rotary button 241 is coaxially arranged with the gear 242. Both of the two strip-shaped annular belts 201 are slidably connected to the casing 242, and the ends of the two strip-shaped annular belts 201 extending into the second cavity 22 are provided with a rack 243 respectively, and the two racks 243 are respectively arranged on the upper and lower sides of the gear 242, and both mesh with the gear 242.

In the above-mentioned embodiment, the casing 244 is provided with the second cavity 22, which can be used to accommodate two strip-shaped annular belts 201 and other components. Specifically, the ends of the two strip-shaped annular belts 201 are slidably arranged in the second cavity. Specifically, the ends of the two strip-shaped annular belts are both slidably arranged in the second cavity 22, and the end of any strip-shaped annular belt 201 is provided with a rack 243, and the second cavity 22 is provided with a gear 242. The two racks 243 are respectively arranged on both sides of the gear 242, so that the advancing directions of the two racks 243 are opposite. In addition, the rear side of the casing 244 is also provided with a rotary button 241, and the rotary button 241 is coaxial with the gear 242. During adjustment, the rotary button 241 can be rotated to drive the gear 242 to rotate through the rotary button 241, and then the two racks 243 can be driven, so as to realize the contraction or enlargement of the rear ring structure 2, so as to meet the use of different users' head sizes and improve the wearing comfort of users.

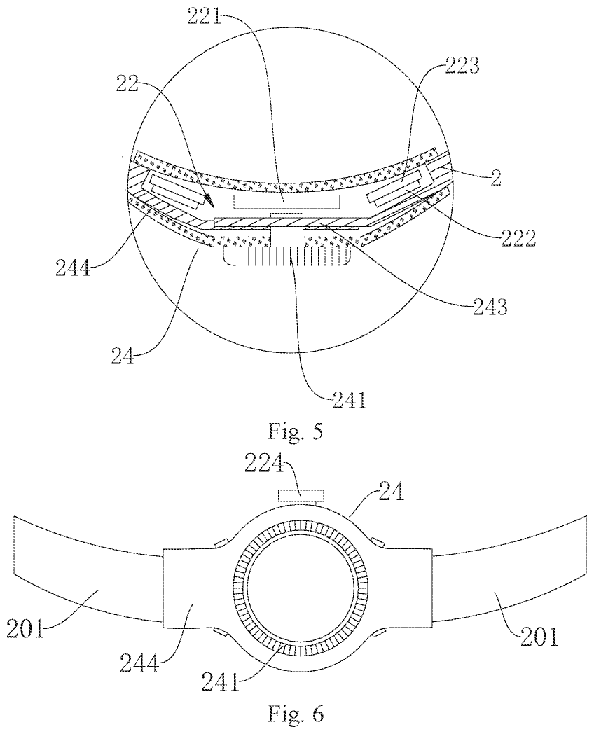

Referring to FIG. 5, in some embodiments of the present application, a power supply device for supplying power to the Bluetooth headset playback component 5 is further comprised, and the power supply device is arranged in the main structure.

In the above-mentioned embodiment, the main structure is also provided with a power supply device, and the power supply device can provide power to the Bluetooth headset playback component 5, so that the Bluetooth headset playback component 5 can work, and can play music, which is convenient for users to listen to music or radio when exercising and thereby delighting the user.

Further, in some implementations of this embodiment, the power supply device comprises a battery 222 and a battery control board 223, and the battery 222 and the battery control board 223 are both arranged in the second cavity 22. It also comprises an operation component 224 arranged in the second cavity 22 and an operation circuit board 221221 electrically connected to the operating component 224. The battery control board 223, the operating circuit board 221 and the Bluetooth headset playback component 5 are all electrically connected to the battery 222.

In the above embodiment, the battery 222 and the battery control board 223 form a power supply module, which can be used to provide power to the Bluetooth headset playback component 5, and also comprises an operation component 224 and an operation circuit board 221 to form an operation module, which is used to control the work of the Bluetooth headset playback component 5, and further forms a complete control system, and the operation is simple and convenient.

Specifically, the operation component 224 may be a physical key control structure, such as a touch key, etc., and the corresponding operation circuit board 221 is a circuit board used for matching the physical keys.

Referring to FIG. 4 , in some embodiments of the present application, the rear ring structure 2 is provided with a first cavity 21 at a position corresponding to the user's ear 7, the first cavity 21 is provided with a speaker 211. The speaker 211 and the battery 222 are electrically connected.

In the above embodiment, the rear ring structure 2 is provided with a first cavity 21 at a position corresponding to the user's ear, which can be used to accommodate the speaker 211. The speaker 211 can increase the external sound of the Bluetooth headset playback component 5, so that the user can better listen to music, etc. Specifically, the first cavity 21 is provided with two, and the corresponding speaker 211 is provided with two, so as to realize binaural listening.

In some implementations of this embodiment, the rear ring structure 2 is further provided with a sound guide structure 232 for guiding the sound emitted by the speaker 211 at the position corresponding to the user's ear 7, and the sound guide structure 232 is close to the user's ear. A sound outlet 231 is provided at the end of the sound guiding structure 232 close to the user's ear.

In the above embodiment, sound guide structures 23 are provided on both the left and right sides of the rear ring structure 2, and the end of the sound guide structure 23 is provided with a sound outlet 231, which can emit sound, and the speaker 211 is connected to the speaker 211 through the sound outlet. The emitted sound is guided to achieve directional sound transmission, so that the sound received by the user's ears is more accurate, thereby reducing the surrounding noisy sound, and realizing binaural listening.

Referring to FIG. 4, in some embodiments of the present application, a positioning module 3 and a step counting function module 4 are further provided on the main structure, and both the positioning module 3 and the step counting function module 4 are electrically connected to the power supply device.

In the above embodiment, the main structure is also provided with a positioning module 3 and a step counting function module 4. The positioning module 3 can enable the device to have a positioning function, and then cooperate with the step counting function module 4 to know the user's movement in real time. The number of steps can enrich the functionality of the equipment and improve the user's preference. Preferably, the positioning module 3 and the step counting function module 4 can be arranged in one of the first cavities.

Specifically, the positioning module 3 may be a commercially available GPS positioning module 3 or a Beidou positioning module 3 with high positioning accuracy, and the step counting function module 4 is the same as that of a commercially available sports product.

Referring to FIGS. 8 and 9, in some embodiments of the present application, the outside of the front ring structure 1 and the rear ring structure 2 are both wrapped with a sweat absorbing structure 8.

In the above embodiment, the sweat absorbing structure 8 is wrapped, which can increase the sweat-absorbing area, thereby better absorbing sweat. The front ring structure 1 cooperates with the sweat-absorbing structure 8 to prevent sweat from entering the eyes and facilitate the user to exercise.

In other implementations of this embodiment, the sweat absorbing structure 8 can also be lined, which has good concealment and enhances the beauty of the equipment. Specifically, the sweat absorbing structure 8 can be a commercially available cotton product, which has a good sweat-absorbing effect.

As a preferred embodiment, the sweat absorbing structure 8, the front ring structure 1 and the rear ring structure 2 can be connected in a detachable manner. In this way, after the sweat absorbing structure 8 is used for a period of time, or after the sweat absorbing structure 8 has absorbed enough sweat, the sweat absorbing structure 8 can be quickly disassembled and replaced with another sweat absorbing structure 8 for easy cleaning.

To sum up, the embodiments of the present application provide a head-mounted sports equipment with freely adjustable length, comprising a ring-shaped main structure, which is configured to be worn on the user's head 6, the main structure comprises a front ring structure 1 and a rear ring structure 2, which are both strip-shaped semi-rings, the ends of the front ring structure 1 and the rear ring structure 2 are provided with quick release structure 25, and the front ring structure 1 and the rear ring structure 2 form an annular main structure by sequential connection of the ends of the quick release structure 25; the main structure is provided with a Bluetooth headset playback component 5 at a position corresponding to the user's ear 7; the rear ring structure 2 is provided with a rotary button adjustment mechanism 24 at the back of the user's head 6, which is configured to adjust the tightness of the rear ring structure 2.

The sports equipment adopts a ring-shaped main structure, which can be worn on the user's head 6, so that the user's movement will not be affected. Specifically, the main structure comprises a front ring structure 1 and a rear ring structure 2. When worn, the front ring structure 1 is located on the user's forehead and the rear ring structure 2 is located on the back of the user's head. The front ring structure 1 and the rear ring structure 2 are both strip-shaped semi-rings, which are small in size and light in weight, which improves the wearing comfort of users. In addition, the ends of the front ring structure 1 and the rear ring structure 2 provide with quick release structure 25, and the front ring structure 1 and the rear ring structure 2 can be connected together in sequence by the quick release structure 25 to form an annular main structure. And it is also easy to disassemble, so as to replace or clean the front ring structure 1 or the rear ring structure 2, and improve the convenience of use. In addition, the main structure is provided with a Bluetooth headset playback component 5 at a position corresponding to the user's ear 7, which can be used to play music, so that this kind of sports equipment not only has the function of headset, but also has no burden after wearing.

Further, the rear ring structure 2 is also provide with a rotary button adjustment mechanism 24 at the back of the user's head for adjusting the tightness of the rear ring structure 2, so that the tightness can be adjusted according to the size of the head 6 of different users. This improves the wearing comfort of the equipment, and adopts a rotary button adjustment mechanism 24, that is, the adjustment can be realized by turning the button, and the operation is simple and convenient.

The above are only the preferred embodiments of the present application, and are not intended to limit the present application. Therefore, any modification, equivalent replacement, improvement, etc. made to the above embodiments according to the technical practice of the present application still fall within the scope of the technical solution of the present application.

What is claimed is:

1. A head-mounted sports equipment with freely adjustable length, comprising a ring-shaped main structure, which is configured to be worn on the head of a user, the main structure comprises a front ring structure and a rear ring structure, which are both strip-shaped semi-rings, the ends of the front ring structure and the rear ring structure are provided with quick release structure, and the front ring structure and the rear ring structure form an annular main structure by sequential connection of the ends of the quick release structure;
the main structure is provided with a Bluetooth headset playback component at a position corresponding to the user's ear;
the rear ring structure is provided with a rotary button adjustment mechanism at the back of the user's head, which is configured to adjust the tightness of the rear ring structure.

2. The head-mounted sports equipment with freely adjustable length according to claim 1, wherein the quick release structure is a pop-up inserting structure.

3. The head-mounted sports equipment with freely adjustable length according to claim 1, wherein the rear ring structure comprises two strip-shaped annular belts, and one end of any one of the strip-shaped annular belts is connected to the end of the quick-release structure, and the other end of any one of the strip-shaped annular belts is connected to the rotary button adjustment mechanism.

4. The head-mounted sports equipment with freely adjustable length according to claim 3, wherein the rotary button adjustment mechanism comprises a casing with a second cavity, a gear is arranged in the second cavity, a rotary button is arranged on the rear side of the casing, and the rotary button is coaxially arranged with the gear;
both of the two strip-shaped annular belts are slidably connected to the casing, and the ends of the two strip-shaped annular belts extending into the second cavity are provided with a rack respectively, and the two racks are respectively arranged on the upper and lower sides of the gear, and both mesh with the gear.

5. The head-mounted sports equipment with freely adjustable length according to claim 4, further comprising a power supply device for supplying power to the Bluetooth headset playback component, the power supply device being provided on the main body structure.

6. The head-mounted sports equipment with freely adjustable length according to claim 5, wherein the power supply device comprises a battery and a battery control board, and the battery and the battery control board are both arranged in the second cavity;
further comprising an operating component arranged in the second cavity and an operation circuit board electrically connected with the operating component, wherein the battery control board, the operation circuit board and the Bluetooth headset playback component are all electrically connected to the battery.

7. The head-mounted sports equipment with freely adjustable length according to claim 6, wherein the rear ring structure is provided with a first cavity at a position corresponding to the user's ear, a speaker is arranged in the first cavity, and the speaker is electrically connected to the battery.

8. The head-mounted sports equipment with freely adjustable length according to claim 7, wherein the rear ring structure is also provided with a sound guide structure for guiding the sound emitted by the speaker at the position corresponding to the user's ear, and an end of the sound guide structure close to the user's ear is provided with a sound outlet.

9. The head-mounted sports equipment with freely adjustable length according to claim 5, wherein the main structure is also provided with a positioning module and a step counting function module, both of which are electrically connected to the power supply device.

10. The head-mounted sports equipment with freely adjustable length according to claim 1, wherein the outside of the front ring structure and the rear ring structure are wrapped with sweat absorbing structure.
